(19) United States
(12) Patent Application Publication
(10) Pub. No.: US 2006/0117355 A1
(43) Pub. Date: Jun. 1, 2006

(54) Pushing content in a two-way network

(76) Inventors: Vincent Dureau, Palo Alto, CA (US); Alain Delpuch, Les Essarts le Roi France (FR)

Correspondence Address: SCHWEGMAN, LUNDBERG, WOESSNER & KLUTH, P.A./OPTV, P.O. BOX 2938, MINNEAPOLIS, MN, 55402-0938, US

(21) Appl. No.: 10/999,209

(22) Filed: Nov. 29, 2004

(51) Int. Cl. H04N 7/173

(52) U.S. Cl. 725/86; 725/87; 725/105; 725/116

(57) ABSTRACT

An apparatus and method enable multicasting a reply to a request for a module to a plurality of receivers on an interactive television network. Requests for multiple modules are packaged into a single request to be transmitted to a broadcast service provider. A request is multicast to a plurality of receivers on the interactive television network and the response to the request is multicast to the plurality of receivers. A user device determines whether to request a module by accessing a list of modules to be multicast by the broadcast service provider within a specific time period. The user device determines whether to perform an action upon accessing a directory listing modules present in a carousel of a broadcast service provider.

### TECHNICAL FIELD

An embodiment of the present invention relates generally to the field of electronic communications, and, more specifically, to the pushing of content in a two-way interactive television network.

### BACKGROUND

Interactive television systems operate to enhance the experience of a content consumer in a number of ways. Content producers and/or distributors are able to provide enhanced services and features to a consumer. For example, interactive television systems may be capable of executing interactive television (iTV) applications that supplement and enhance the viewing experience of a user. A wide range of interactive television applications may be provided to a user via an interactive television system, ranging from interactive program guides (IPGs) to games and the like.

Interactive television applications may also be attractive to a content consumer because, such applications elevate a television viewing experience from a purely passive activity to an active, or interactive, activity. For example, a shopping interactive television application may enable a user to interactively place orders for products being advertised via a television broadcast.

An interactive television application is typically delivered from a headend of a broadcast service provider to a set-top box (STB) of a consumer as part of a broadcast transmission. Such a broadcast may include a television content portion (e.g., audio and video) and an interactive portion. The interactive portion may include application code and control information for an interactive television application. The service provider typically combines the television content and interactive portions of the broadcast into a single signal that is broadcast to a user location.

At the user end, a user device (e.g., the set-top box (STB)) receives the broadcast, extracts the interactive portion thereof, and composes and executes one or more interactive television applications that are embodied in the interactive portion of the broadcast.

The user device, in addition to extracting and executing the interactive television application, may also be provided with a transmission capability whereby the user device can communicate from the user location back to a broadcast service provider or to other users, for example via a public network (e.g., the Internet) or a private network (e.g. a Pay TV operator intranet). In this fashion, the user device might request a specific application to be transmitted from the broadcast service provider. The broadcast service provider may then transmit the application to the individual user location. If the application is sent on a shared medium (e.g. the broadcast network), other user devices connected to the same network will ignore the requested application. Therefore, each of the other user devices must individually make a request for the application and the broadcast service provider must reply to each of these redundant requests individually. It should be noted that on a two-way digital cable today, the network may include in effect two networks using different frequencies on the same physical link. One may be a broadcast network and the other may be a bi-directional network that can be used both in a point-to-point and in a broadcast mode. Note that on any IP network, point-to-point and broadcast protocols can coexist as well.

### SUMMARY OF THE INVENTION

According to one aspect of the present invention, there is provided an apparatus and method to enable multicasting a reply, to a request for a module, to a plurality of receivers on an interactive television network. According to another aspect of the present invention, requests from multiple modules may be packaged into a single request to be transmitted to a broadcast service provider. According to yet another aspect of the present invention, a request is multicast to a plurality of servers (at least the one that will serve the request) and receivers on the interactive television network and the response to the request is multicast to the plurality of servers and receivers. In the event that there are multiple servers, multicasting the request may help for load balancing across servers—e.g., they all may receive the request and then decide which one should reply—other servers who could potentially reply decide not to reply as soon as they see a reply simulcast on the network. According to another aspect of the invention, a user device may determine whether to request a module by accessing a list of modules to be multicast by the broadcast service provider within a specific time period. According to another aspect of the invention, a user device may determine whether to perform an action upon accessing a directory listing modules present in a carousel of a broadcast service provider.

Other features will be apparent from the accompanying drawings and from the detailed description that follows.

### BRIEF DESCRIPTION OF THE DRAWINGS

An exemplary embodiment of the present invention is illustrated by way of example and not limitation in the figures of the accompanying drawings, in which like references indicate the same or similar elements and in which:

FIG. 1A is a diagrammatic representation of an exemplary interactive television environment within which the present invention may be deployed;

FIG. 1B is a diagrammatic representation of the interactive television environment illustrating exemplary details of the source system and the receiver system;

FIG. 2 is a block diagram providing architectural details regarding a headend system and a set-top box, according to an exemplary embodiment of the present invention;

FIG. 3 is a diagrammatic representation of a data stream that may be outputted from a multiplexer of a headend system, according to one embodiment of the present invention;

FIG. 4 is a flowchart illustrating a method, according to one exemplary embodiment of the present invention, to multicast a reply to a request from a module to a plurality of receiver systems in an interactive television environment;

FIG. 5 is a flowchart illustrating a method, according to one exemplary embodiment of the present invention, to package requests for multiple modules into a single request transmitted on an interactive television environment;

FIG. 6 is a flowchart illustrating a method, according to one exemplary embodiment of the present invention, to multicast a reply to a multicast request for a module in an interactive television environment;

FIG. 7 is a flowchart illustrating a method, according to one exemplary embodiment of the present invention, to multicast a list of modules that are to be multicast from a source system in an interactive television environment;

FIG. 8 is a flowchart illustrating a method, according to an exemplary embodiment of the present invention, to multicast a directory of modules that will or will not be transmitted to in the future from a source system in an interactive television environment; and

FIG. 9 is a block diagram illustrating a machine, in the exemplary form of a computer system, which may store and execute a set of instructions that cause the machine to perform any of the methods described herein.

### DETAILED DESCRIPTION

A method and a system for pushing content in a two-way interactive television network environment are described. In the following description, for purposes of explanation, numerous specific details are set forth in order to provide a thorough understanding of the present invention. It will be evident, however, to one skilled in the art that the present invention may be practiced without these specific details.

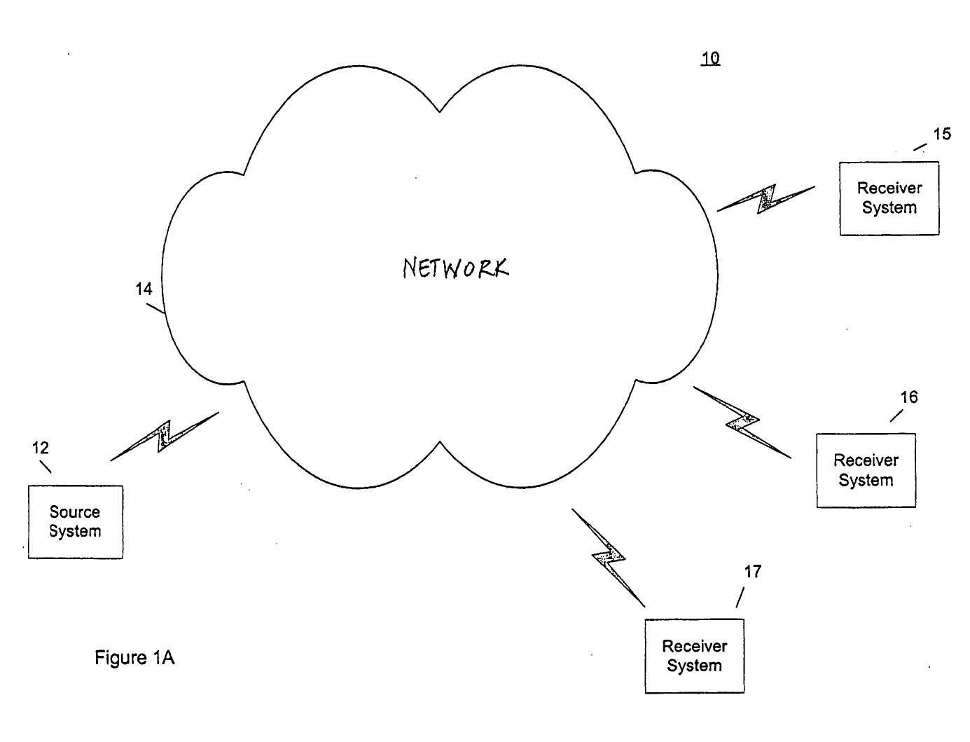

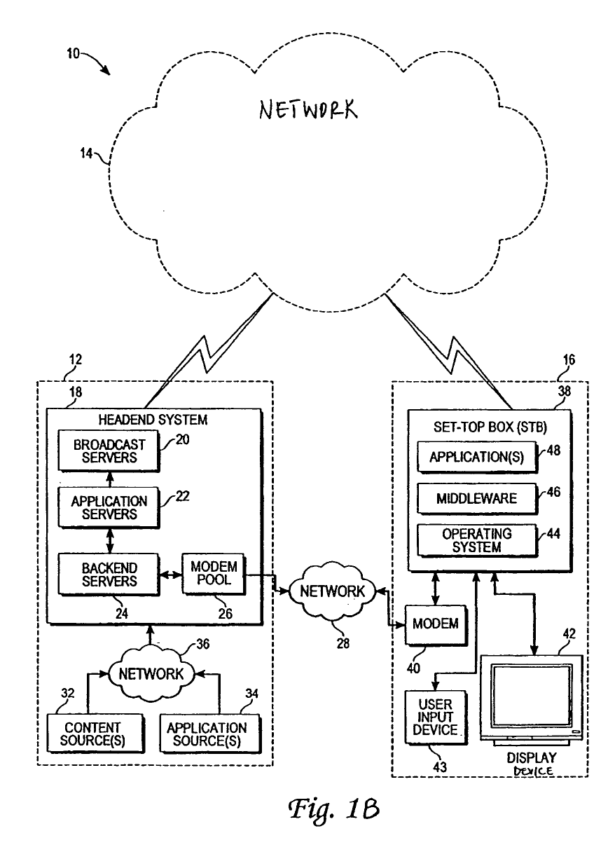

FIG. 1A is a diagrammatic representation of an exemplary interactive television environment 10, in conjunction with which the present invention may be deployed. The interactive television environment 10 includes a source system 12 that communicates data (e.g., television content and interactive application data) via a distribution system 14 to a number of receiver systems 15, 16, and 17. It will be appreciated that the distribution system 14 may any communication system capable of communicating data and may, for example, include a national or local Telco network or the like. FIG. 1B is a diagrammatic representation of the interactive television environment 10 illustrating exemplary details of the source system 12 and the receiver system 16.

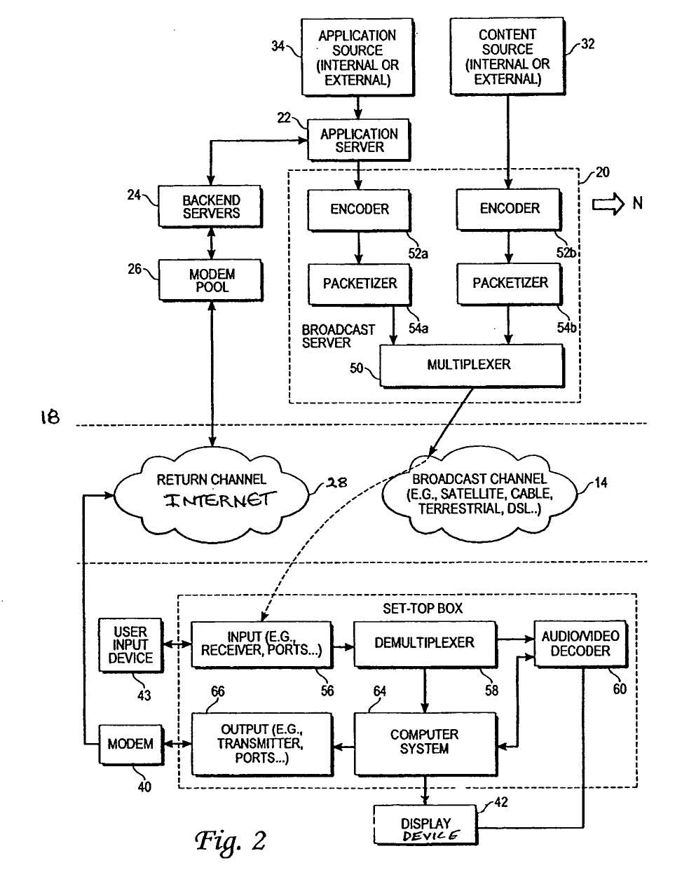

Turning first to the source system 12, a headend system 18 operates to communicate the data as a broadcast transmission. To this end, the headend system 18 is shown to include one or more broadcast servers 20 and one or more application servers 22. Each of the broadcast servers 20 may operate to receive, encode, packetize, multiplex, and broadcast data from various sources and of various types. In various embodiments, data could also be transmitted from the source system 12 via a network connection to the receiver system 16. Further details regarding an exemplary broadcast server 20 are provided below with reference to FIG. 2.

Each application server 22, in one exemplary embodiment, serves to compile and provide modules to the broadcast server 20. The modules may include application code, data (e.g., updated statistics and scores for sporting events, news feeds, etc.), or any other data (e.g., motion picture experts group (MPEG) still pictures, etc.) utilized by an interactive television application. The modules of the present invention may be portable across all transmission media and, accordingly, may contain no specialization for any particular communication channel. A module may be signed, unsigned, compressed or uncompressed. An application server 22 may include multiplexing functionality to enable multiplexing of, for example, interactive television applications and associated data with audio and video signals received from various sources. An application server 22 may also have the capability to feed (e.g., stream) multiple interactive television applications to one or more broadcast servers 20 for distribution to the receiver system 16. To this end, each application server 22 may implement a so-called “carousel”, whereby code and data modules are provided to a broadcast server 20 in a cyclic, repetitive manner for inclusion within a transmission from the headend system 18.

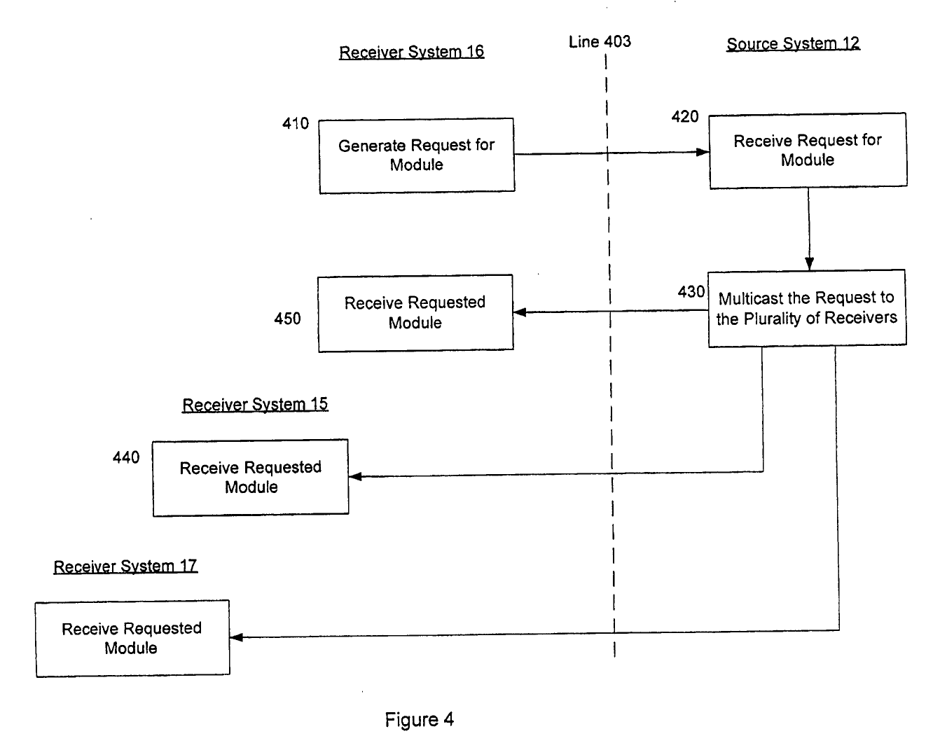

The headend system 18 is also shown to include one or more backend servers 24, which are coupled to the application servers 22 and to a communications I/O interface such as an exemplary modem pool 26. Specifically, the modem pool 26 is coupled to receive data from the receiver systems 16 via a network 28 (e.g., the Internet) and to provide this data to backend servers 24. The backend servers 24 may then provide the data, received from the receiver system 16, to the application servers 22 and the broadcast servers 20. Accordingly, a network 28 and the modem pool 26 may operate as a return channel whereby a receiver system 16 is provided with interactivity with the source system 12. Data provided to the headend system 18 via the return channel may include, merely for example, user input to an interactive television application executed at the receiver system 16 or data that is generated by the receiver system 16 and communicated to the source system 12. The network 28 may also provide a channel whereby programs and applications are requested from the source system 12 to be provided to the receiver system 16 as will be further described below in conjunction with FIGS. 4-8.

Within the source system 12, the headend system 18 is also shown optionally to receive data (e.g., content, code and application data) from external sources. FIG. 1B illustrates the headend system 18 as being coupled to one or more content sources 32 and one or more application sources 34 via a network 36 (e.g., the Internet). For example, a content source 32 could be a provider of entertainment content (e.g., movies), or a provider of real-time dynamic data (e.g., weather information). An application source 34 may be a provider of any interactive television application. For example, one or more application sources 34 may provide Electronic Program Guides (EPG) and navigation applications, messaging and communication applications, information applications, sports applications, and/or games and gaming applications.

Turning now to the distribution system 14, the distribution system 14 may, in one embodiment, support the broadcast distribution of data from the source system 12 to the receiver system 16. The distribution system 14 may include a satellite, cable, terrestrial or Digital Subscribers Line (DSL) network, or any combination of such networks or other networks well known to those of ordinary skill in the art.

The receiver system 16 is shown, in one exemplary embodiment, to include a set-top box (STB) 38 that receives data via the distribution system 14; a communications I/O interface such as an exemplary modem 40 for return channel communications with the headend system 18 and optionally other external systems, a user input device 43 (e.g., a keyboard, remote control, mouse etc.) and a display device 42, coupled to the set-top box 38, for the display of content received at the set-top box 38. In one exemplary embodiment, the display device 42 may be a television set. It will be appreciated that the communications I/O interfaces may be selected dependent upon the nature of the network 28. For example, the communications I/O interface 28 may include a cable return module, a DSL return module, or the like.

The set-top box 38 may execute three layers of software, namely an operating system 44, middleware 46 and one or more interactive television applications 48. The middleware 46 operates to shield the interactive television application 48 from the differences of various operating systems 44 and in hardware of different set-top boxes 38. To this end, the middleware 46 may provide driver Application Program Interfaces (APIs) and a library to translate instructions received from an interactive television application 48 into low-level commands that may be understood by set-top box hardware (e.g., modems, interface ports, smart card readers, etc.).

FIG. 2 is a block diagram illustrating further details regarding the architecture of a headend system 18 and a set-top box 38, as may be deployed as part of an exemplary embodiment of the present invention. Specifically, FIG. 2 shows a broadcast server 20, which may support a carousel of modules, as including a number of parallel paths that provide input to a multiplexer 50, each of the parallel paths including an encoder 52 and a packetizer 54. Each encoder 52 may operate to receive input from one or more sources. For example, the encoder 52a is shown to receive streamed code modules from an application server 22, which is in turn coupled to receive application data from one or more application sources 34. The application source 34 may be internal or external to a headend system 18. Similarly, an encoder 52b is shown coupled to receive content data from one or more content sources 32, which may again be internal or external to the headend system 18.

It will be appreciated that each broadcast server 20 may include any number of parallel paths coupled to any number of sources (e.g., application and/or content sources 34 and 32) that provide input to the multiplexer 50. Furthermore, a headend system 18 may deploy any number of broadcast servers 20.

Each of the encoders 52 operates to encode data utilizing any one or more of a number of compression algorithms, such as, for example, the Motion Picture Expert Group (MPEG) comparison algorithms. Each of the encoders 52 may also operate to time stamp data that needs to be encoded. Time stamps may also be adjusted downstream by multiplexers. Certain data types may not be susceptible to encoding and thus, may pass through, or by-pass, the encoder 52, and be provided to a packetizer 54 in an unencoded state. In one embodiment, code and most data types may bypass the encoders 52.

The packetizers 54 are coupled to receive data and to format this data into packets before eventual transmission via the distribution system 14 (e.g., a broadcast channel).

Each of the packetizers 54 provides packets to the multiplexer 50, which multiplexes the packets into a transmission signal for distribution via the distribution system 14.

The set-top box 38 of a receiver system 16 is typically coupled to a network input (e.g., a modem), cable input, satellite dish or antenna so as to receive the transmission signal, transmitted from the headend system 18 via the distribution system 14. The transmission signal is then fed to an input 56 (e.g., a receiver, port, etc.). Where the input 56 includes a receiver, the input 56 may, for example, include a tuner (not shown) that operates to select a broadcast channel on which the transmitted signal is broadcast. It will be appreciated that in a DSL environment no tuner may be provided. The packetized transmission signal is then fed from the input 56 to a demultiplexer 58 that demultiplexes the application and content data that constitutes the transmission signal. Specifically, the demultiplexer 58 provides the content data to an audio and video decoder 60, and the application data to a computer system 64. The audio and video decoder 60 decodes the content data into, for example, a television signal. For example, the audio and video decoder 60 may decode the received content data into a suitable television signal such as a National Television Systems Committee (NTSC), Phase Alternation Line (PAL), or High Definition Television (HDTV) signal. The television signal is then provided from the audio and video decoder 60 to the display device 42.

The computer system 64, which may include a processor and memory, reconstructs one or more interactive television applications from the application data that is provided to it by the demultiplexer 58. As mentioned above, the application data may include both application code and/or application information that is used by an interactive television application 48. The computer system 64, in addition to reconstructing an interactive television application 48, executes such an application 48 to cause the set-top box 38 to perform one or more operations. For example, the computer system 64 may output a signal to the display device 42. For example, this signal from the computer system 64 may constitute an image or graphical user interface (GUI) to be overlaid on an image produced as a result of the signal provided to the display device 42 from the audio and video decoder 60. A user input device 43 (e.g., a keyboard, remote control, mouse, microphone, camera etc.) is also shown to be coupled to the input 56, so as to enable a user to provide input to the set-top box 38. Such input may, for example, be alphanumeric, audio, video, or control (e.g., manipulation of objects presented in a user interface) input.

The computer system 64 is also shown to be coupled to the audio and video decoder 60 so as to enable the computer system 64 to control this decoder 60. The computer system 64 may also receive an audio and/or video signal from the decoder 60 and combine this signal with generated signals so as to enable the computer system 64 to provide a combined signal to the display device 42.

The computer system 64 is also shown to be coupled to an output 66 (e.g., a transmitter, output port, etc.) through which the set-top box 38 is able to provide output data, via the return channel 28, to an external system, such as for example, the headend system 18. To this end, the output 66 is shown to be coupled to the modem 40 of the receiver system 16.

While the receiver system 16 is shown in FIGS. 1A, 1B and 2 to include a set-top box 38 coupled to a display device 42, it will readily be appreciated that the components of the receiver system 16 could be combined into a single device (e.g., a computer system), or could be distributed among a number of independent systems. For example, a separate receiver unit may provide input to a set-top box 38, which is then coupled to a display device 42.

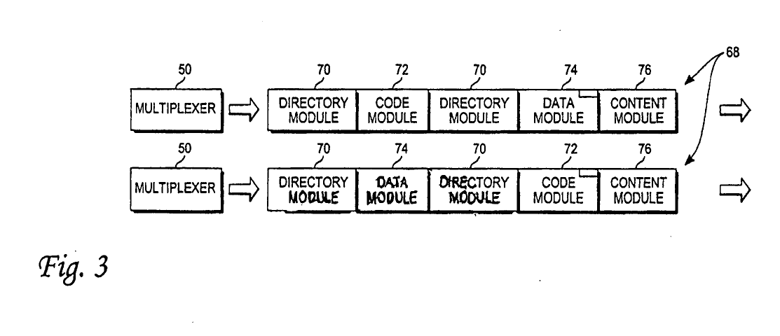

FIG. 3 is a diagrammatic representation of an exemplary data stream 68 that may, according to one exemplary embodiment, be outputted from each of a number of multiplexers 50 deployed in headend system 18. In the exemplary interactive television environment 10, the application and content data may be presented to a broadcast server 20 as distinct modules. For example, the application data may constitute directory modules 70, code modules 72 and data modules 74. The content information may be included within content modules 76. In one embodiment, no distinction is made between code and data modules and data and code may thus be mixed. In another embodiment, each of the modules 70-76 is uniquely identified as being of a particular module type. A directory module 70 may have a unique identifier so as to enable it to be identified within a data stream 68 without further information. A directory module 70 furthermore contains information constituting a directory of one or more other modules such as code modules 72 and data modules 74 that form a particular interactive television application. Accordingly, a set-top box 38 may utilize a directory module 70 to identify all code modules 72 and/or data modules 74 that are required for assembling and executing an interactive television application. In one embodiment, the directory module 70 may be accessed and processed prior to the other modules, so as to enable the set-top box 38 to correctly identify and interpret other modules included within a data stream 68. In another embodiment, the directory module 70 is used to retrieve a list of modules as well as flags attached for each module, for example, to specify whether a module is auto-exec or auto-load module. As mentioned above, a headend system 18 may implement a carousel whereby the modules 70-76 are transmitted in a cyclic, repetitive manner.

At times, the receiver system 16 may transmit a request, via the network 28, for one or more modules to be transmitted by the source system 12. According to one embodiment, the receiver system 16 will multicast the requested module, as shown, by example, in a multicast response process flow 400 illustrated in FIG. 4. Process flow 400 illustrates the separation of the processing on the receiver system 16 side and the source system 12 side by line 403.

At block 410, the receiver system 16 generates a request for a module from the source system 12. For example, the receiver system 16 may request a module, as described with reference to FIG. 3 above, which relates to an application associated with a television commercial. This code module may enable the user to receive additional information related to the product being advertised during the commercial.

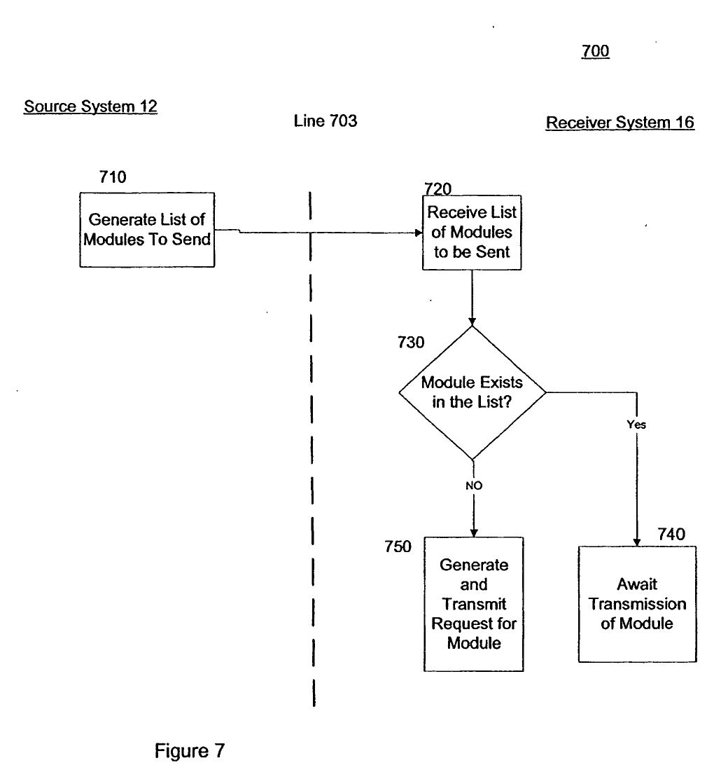

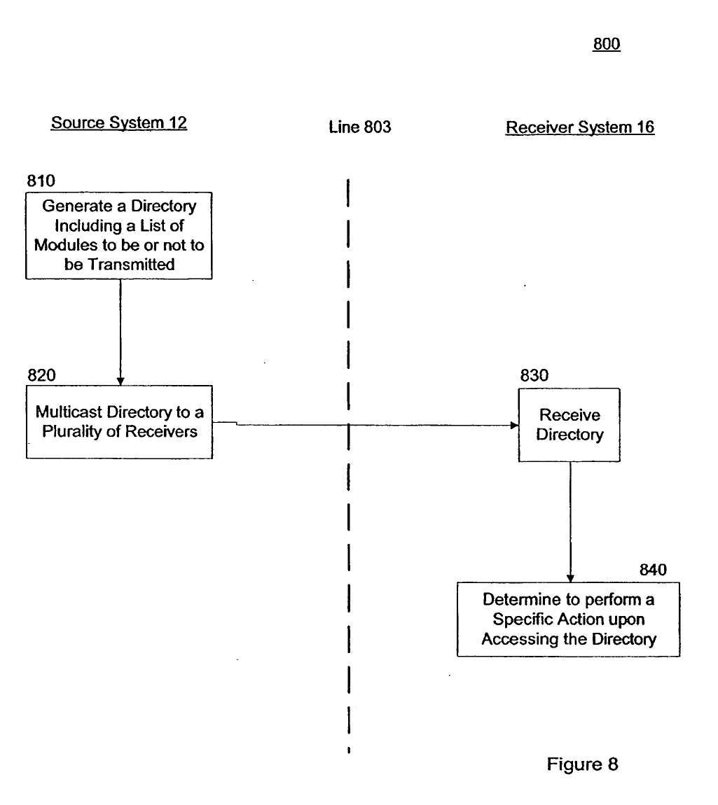

At block 420, the source system 12 receives the request for the module from the receiver system 16. At block 430, the source system 12 multicasts the request to a plurality of receivers (15, 16, 17), including the receiver system 16 that requested the module. At blocks 440 and 450, the receiver systems 15 and 16 receive the requested modules. In this fashion, instead of redundantly receiving requests for and transmitting requested modules, the source system 12 can multicast modules once. Furthermore, multiple receiver systems (15, 16, 17) listening to the same multicast can acquire the same module. The receiver system 16 who requested the module will be ready to receive it, and the other receiver systems (15, 17) that desire the same module may acquire it as well. In addition, the other receiver systems (15, 17) may defer requesting a sought after module upon determining the sought after module is to be multicast within a specific time period, as illustrated below in conjunction with FIGS. 7 and 8. In an alternative embodiment, a receiver system may multicast a request for one or more modules to the other receivers systems on the network, whereby the other receiver systems may defer requesting a sought after module for a period of time. In this fashion, the other receiver systems may wait for the sought after module and do not send redundant requests for common modules. In one embodiment, the receivers store a play list of the modules for a given application. For example, the playlist may be sent at the same time as the application. When receivers detect a module multicast on the network, they can deduce from the playlist which modules will play next. Another exemplary way for the receivers to know where the server is in the playlist may be based on timing information (e.g. the time since the TV program or the application started, or a clock that is broadcast on the channel). The receivers can use the timing information combined with the playlist to know which modules will be transmitted next.

In one exemplary embodiment, multiple requests from a receiver system may be packed or grouped into a single communication. A single request (or packed request(s)) may include timing information that indicates when a request should be served. For example, the timing information may indicate that a request should not be served earlier that an identified time, not later than an identified time, and so on. Thus, the source system 12 may serve each request in the plurality of requests sequentially or serve the plurality of requests all at once. In one exemplary embodiment, the source system 12 extracts timing information from the request and serves the request based on the timing information. The timing information may indicate that the request should be served no earlier or no later than an identified time.

It should be appreciated that the process flow 400 may reduce bandwidth utilization on the forward path because the requested module is acquired by multiple receiver systems (15, 16, 17) at the same time. Also, the bandwidth utilization may be reduced on the return path because the receiver systems (15, 16, 17) that receive a module requested by another receiver do not need to send a request for the same module. Further, receiver systems that have enough storage space can decide to pre-fetch and cache modules before they even need them. The process flow 400 may also reduce the load on the processor of the receiver system 16 by reducing the amount of data sent to a receiver that is not needed by that receiver. In addition, the process flow may reduce the amount of processing required on the server side, since the servers will have to process and serve fewer requests.

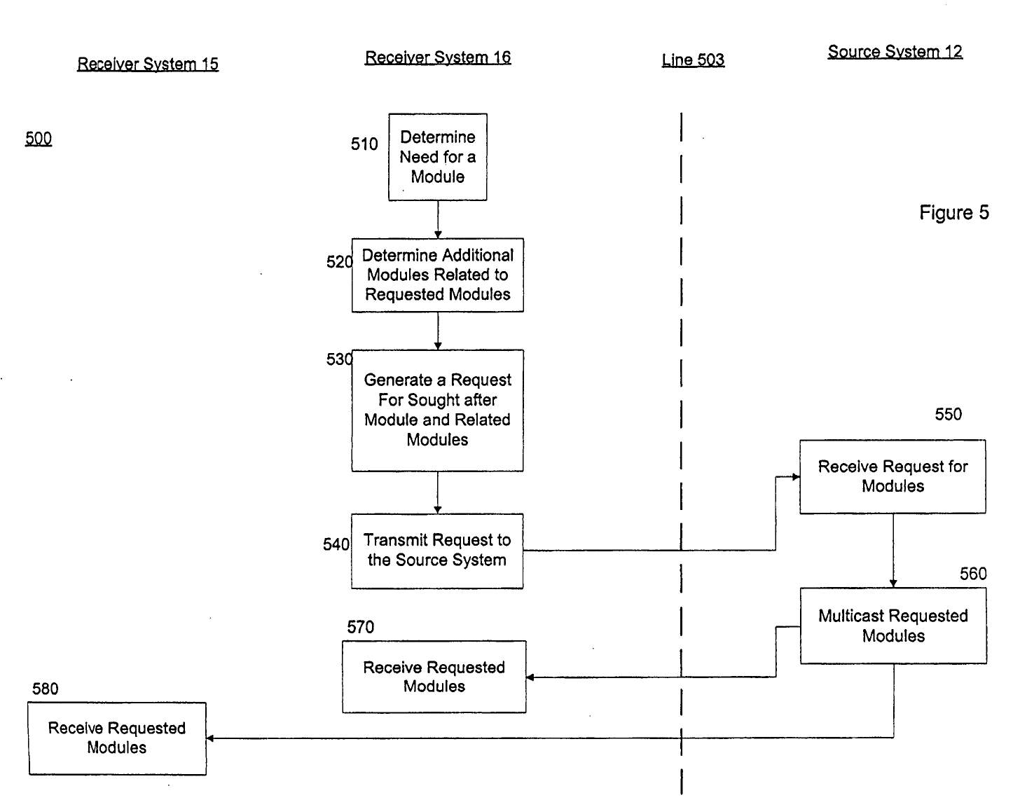

Multiple modules may be needed to perform an interactive television task at the receiver system 16. For example, an interactive television application may be divided into multiple application code modules or require specific data modules to operate. Therefore, a request for a specific module may commence additional requests for additional related modules. According to one embodiment, the receiver system 16 packages requests for multiple modules into a single request as shown, by example, in a package requests process flow 500 as illustrated in FIG. 5. Process flow 500 illustrates the separation of the processing on the receiver system 16 side and the source system 12 side by line 503.

At block 510, the receiver system 16 determines the need for a module. For example, the receiver system 16 may need to request a code module from the source system 12 to perform a specific interactive function associated with a program being broadcasted. At block 520, the receiver system 16 determines additional modules related to the requested module. Continuing the example, the receiver system 16 may identify one or more data modules that are associated with the requested code module. In one exemplary embodiment, the receiver system 16 stores an application specific list that maps related or additional modules or sequence of modules that may be required. In one exemplary implementation the list is sent at the same time as the application (e.g. in a specific module). The list may be discarded from the receiver memory at the same time as other application code and data, for example when the application is terminated.

At block 530, the receiver system 16 generates a request for the sought after module and the related modules. At block 540, the receiver system 16 transmits the request for the modules to the source system 12. At block 550, the server system 12 receives the request for modules. At block 560, the source system 12 multicasts the requested modules to a plurality of receivers (15, 16, 17) including the receiver system 16. At blocks 570 and 580, the receiver systems 15 and 16 receive the requested module.

It should be appreciated that process flow 500 reduces the number of sequence requests to the source system 12 on the return channel 28 and the number of responses to the sequence request to the receiver system 12 on the forward path via the distribution system 14. It may also reduce the size of the server farm required to process requests as the server farm will have fewer requests to process and serve.

The receiver system 12 need not always determine the related modules as illustrated in block 520. Rather, in one embodiment, the source system 12 may decide to multicast one or more associated modules (e.g., a sequence of modules) when it receives a request for at least one module from at least one receiver. For example, if an application comprises a set of modules that are needed in sequence, the source system 12 can decide to multicast this sequence of modules. For example, the source system 12 can decide to multicast a sequence of modules starting at module n any time a request for module n is received.

As will be described further below with reference to FIGS. 7 and 8, other receiver systems in the television environment 10 do not need to send a request for module p where p>=n in an ordered sequence. In this fashion, if the receiver system 15 identifies a request for module n being sent by the receiver system 16 on the network 28 or identifies module n being transmitted on the distribution system 14, the receiver system 15 may know that module p will be multicast after (not necessarily immediately after) module n Thus, in an ordered sequence the multicasting of one module may provide an indication that another module will follow (e.g., the other module may follow in due course, immediately afterwards, or at any other time) and the receiving system 15 does thus not need to send a request for the exemplary module p where p>=n in the ordered sequence. In an alternative embodiment, the receiver systems (15, 16, 17) may multicast their requests for modules on the distribution system 14, in order for other receiver systems (15, 16, 17) not to send redundant requests for common modules.

In one embodiment, such a sequence of modules could be automatically generated off-line or in real-time by analyzing the carousel generated for a particular service. Using this methodology, each module can be sent once or repeated. The optimization of traffic between a forward path bandwidth (repeating modules) and a return path bandwidth (sending requests) can be performed either off-line (e.g., producing play-lists of modules to send or analyzing carousels) or in real-time (e.g., analyzing traffic). This technique allows optimizing usage of forward and return path bandwidth based on criteria such as cost, saturation, and performance. An example of real-time optimizing techniques would be to broadcast the content that has been asked for; so that highest priority goes to explicit requests. In that category, the more the data or module has been requested, the higher the chance it should get to be broadcast soon. Now, when there are no explicit requests, the bandwidth may be used to transmit in a carousel the data or modules most likely to be requested. In these circumstances, a priority based on popularity of requests and date of last transmission could be used.

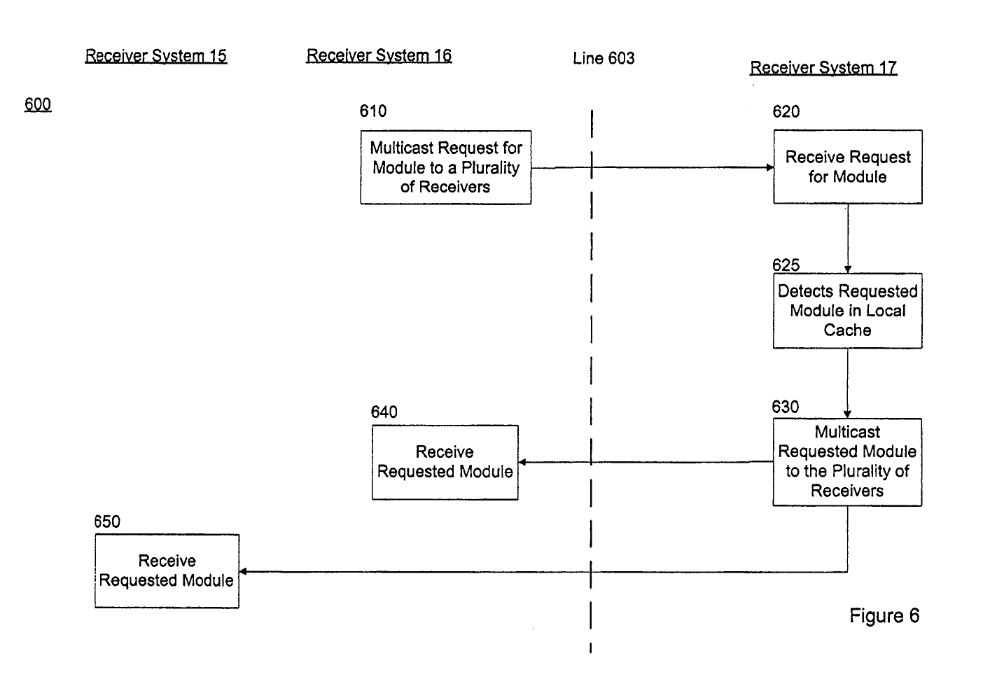

In another embodiment, the receiver system 16 may request and obtain one or modules from the other receiver systems (15, 17) on the network (e.g., a peer-to-peer network environment). For example, FIG. 6 illustrates one embodiment of a broadcast request process flow 600. Process flow 600 illustrates the separation of the processing on the side of the receiver system 16 and the side of the receiver system 17 by line 603.

At block 610, the receiver system 16 multicasts a request for a module to a plurality of receivers including the receiver system 17. At block 620, the receiver system 17 receives the request for the module. At block 625, the receiver system 17 may, for example, detect the requested module in its local cache. If so, at block 630, the receiver system 17 multicasts the requested module to the plurality of receiver systems (including the receiver systems 15 and 16). At blocks 640 and 650, the receiver systems 15 and 16 receive the requested module. In one exemplary embodiment, in order to inhibit all receivers from responding to a request, receivers do not serve requests for modules that have been multicast by other receivers. As a consequence, all receivers may stop responding automatically when all modules have been served. In a combined peer to peer/client-server model, the server would apply the same strategy as the peers.

As stated above, the receiver systems (15, 16, 17) on the network may benefit from knowing which modules have been requested or otherwise are scheduled to be transmitted by the source system 12 within a specific time frame. FIG. 7 illustrates one embodiment of a module schedule for a multicast process flow 700 for transmitting a list of modules to be transmitted from the source system 12 within a specific time period. Process flow 700 illustrates the separation of the processing on the source system 12 and the receiver system 16 by line 703.

At block 710, the source system 12 generates a list of modules scheduled to be multicast to the plurality of receiver systems. The list of modules may include timing information about when specific modules will be transmitted. The list may be generated off-line or in real-time, for example by analyzing the carousel generated for a particular service. An example where the list can be generated off-line is when a TV program is a pre-recorded quiz game show. The application allows viewers to play along with the game show. Each question and answer pair may be transmitted in a separate module. The list may be generated by watching the show, writing down the time from the beginning of the show when a particular question is about to be answered.

At block 720, the receiver system 16 receives the list of modules from the source system 12. At block 730, the receiver system 16 determines whether a sought-after module exists in the list. If the receiver system 16 determines the sought-after module is in the list of modules, control passes to block 740. If the receiver system 16 determines the sought-after module is not in the list of modules, control passes to block 750.

At block 740, the receiver system 16 determines that the sought-after module is in the list of modules and awaits the module to be multicast from the source system 12. The receiver system 16 may wait for the module to be multicast on a specific broadcast channel and/or at a specific time based on the information stored in the list. In one embodiment, if the receiver system 16 does not receive the sought-after module within a specific amount of time, control may pass to block 750. At block 750, the receiver system 16 generates and transmits a request. The source system 12 can multicast the list of modules it will multicast (optionally with timing information about when certain modules will be transmitted), so that other receiver systems, who need some of the modules to be transmitted, do not need to transmit requests for these modules. In this fashion, the process flow 700 reduces traffic on the network 28 and also reduces the size of the server farm required to process requests.

In yet another embodiment, the receiver system 16 may receive a directory that lists all the modules potentially present in a carousel. FIG. 8 illustrates one embodiment of a send directory process flow 800. Process flow 800 illustrates the separation of the processing on the source system 12 and the receiver system 16 by line 803.

At block 810, the source system 12 generates a directory. The directory includes a list of modules that are currently present in the carousel, a list of modules that will be transmitted later by the carousel, or a list of modules that will not be transmitted within a specific time period. For example, some carousel formats (including OpenTV and DSM-CC (Digital Storage Media—Command and Control)) transmit a directory that lists all the modules potentially present in the carousel.

At block 820, the source system 12 multicasts the directory to a plurality of receiver systems. At block 830, the receiver system 16 receives the directory. At block 840, the receiver system 16 accesses the directory to determine whether to perform a specific action. For example, in the case of an interactive advertisement over a 30 second spot, the receiver system 16 may decide not to launch an application or an application may decide to exit if a particular module has been missed, if, for example, the viewer turned to the commercial too late into the spot. In one exemplary embodiment, lists in the process flow 700 do not necessary cover the entire life of the application. The fact that a module does not appear in the list does not mean that it will never be transmitted later. As a consequence, in this exemplary embodiment receiver systems can send requests to the server for modules that do not appear in the list. However, in the exemplary process flow 800, the list may cover the entire life of the application. If a module is described in the list as never to be transmitted again, or does not appear in the list, this could mean that the application should not expect to ever receive the module. As a consequence, the application could for example decide to exit if it needs a module that it knows, according to the list, will never be transmitted. Note that this methodology may also apply to receiver systems that are not connected to the return path or have not sent requests to the server.

In conclusion, one embodiment of the present invention described reduces the redundant request for modules to be transmitted to the source system 12 and the number of times a module will be transmitted on a forward path to a plurality of receivers. Furthermore, one embodiment of the invention enables a receiver system to determine whether a module is to be transmitted from the source system 12 within a specific time, whereby the receiver might decide whether to wait for or request the module from the source system 12.

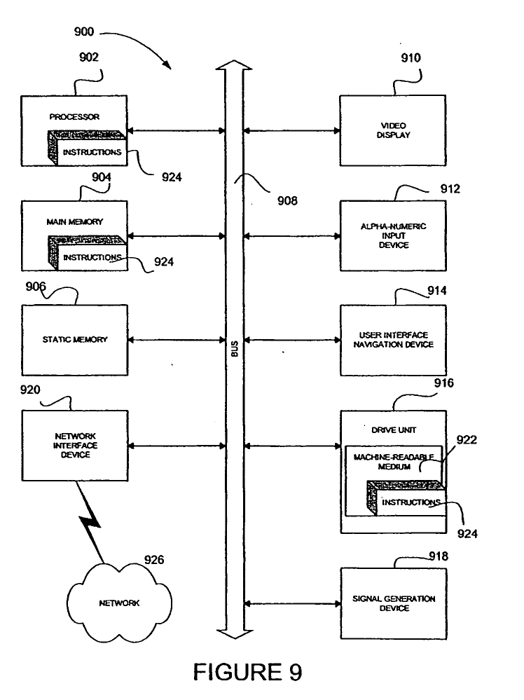

FIG. 9 is a block diagram illustrating a machine, in the exemplary form of a computer system 900 within which a set of instructions for causing the machine to perform any one or more of the methodologies discussed herein, may be executed.

The machine may operate as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a server, personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 900 includes a processor 902 (e.g., a central processing unit (CPU), a graphics processing unit (GPU), or both), a main memory 904 and a static memory 906, which communicate with each other via a bus 908. The computer system 900 may further include a video display unit 910 (e.g., a liquid crystal display (LCD) or a cathode ray tube (CRT)). The computer system 900 also includes an alphanumeric input device 912 (e.g., a keyboard), a user interface (UI) navigation device 914 (e.g., a mouse), a disk drive unit 916, a signal generation device 918 (e.g., a speaker) and a network interface device 920.

The disk drive unit 916 includes a machine-readable medium 922 on which is stored one or more sets of instructions (e.g., software 924) embodying any one or more of the methodologies or functions described herein. In certain embodiments, code necessary to perform various functions may be embedded software stored in Flash, while application code and data may be loaded from the network into RAM. The software 924 may also reside, completely or at least partially, within the main memory 904 and/or within the processor 902 during execution thereof by the computer system 900, the main memory 904 and the processor 902 also constituting machine-readable media (executed directly or indirectly by the machine).

The software 924 may further be transmitted or received over a network 926 via the network interface device 920.

While the machine-readable medium 992 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention.

Thus, a method and system for pushing content in a two-way interactive television environment have been described. Although the present invention has been described with reference to specific exemplary embodiments, it will be evident that various modifications and changes may be made to these embodiments without departing from the broader scope of the invention. Accordingly, the specification and drawings are to be regarded in an illustrative rather than a restrictive sense.

What is claimed is:

1. A device including:
a headend system to receive a request for at least one module and to multicast a reply to the request to a plurality of receiver systems on an interactive television network.

2. The device of claim 1, wherein the request is received from a first receiver system of the plurality of receiver systems on the interactive television network.

3. The device of claim 1, wherein the device is a source system and the interactive network comprises a forward path via which the at least one module is transmitted to the plurality of receiver systems, and a return path via which requests for the at least one module are communicated from a receiver system to the source system.

4. The device of claim 1, which communicates a plurality of modules to at least one receiver system, the plurality of modules comprising a directory module which comprises information on other modules for communication to the receiver system.

5. A method for replying to a module request on an interactive television network, the method comprising:
receiving a request for at least one module from a first receiver system, the first receiver system being one of a plurality of receiver systems; and
multicasting the at least one module to the plurality of receiver systems.

6. The method of claim 5, further comprising:
receiving and storing the multicast module at a second receiver system, the second receiver system being one of the plurality of receiver systems.

7. The method of claim 5, which comprises:
receiving a plurality of requests packaged into a single communication; and
serving each request in the plurality of requests sequentially.

8. The method of claim 5, which comprises:
receiving a plurality of requests packaged into a single communication; and
serving the plurality of requests all at once.

9. The method of claim 5, which includes:
extracting timing information from the request; and
serving the request based on the timing information.

10. The method of claim 9, wherein the timing information indicates that the request should be served no earlier or no later than an identified time.

11. A system comprising:
a receiver system on an interactive television network, the receiver system to determine at least one module associated with a sought after module and to generate a request for the associated module.

12. The system of claim 11, further comprising:
a source system, wherein the receiver system is to transmit the request to the source system.

13. The system of claim 12, wherein the receiver system is one of a plurality of receiver systems.

14. The system of claim 13, wherein the source system is to receive the request and multicast the at least one associated module to the plurality of receiver systems.

15. A method for packaging requests on an interactive television network, the method comprising:
at a receiver system, determining at least one module associated with a sought after module; and
generating a request for the associated module to be transmitted to a source system.

16. The method of claim 15, which comprises packing a plurality of requests into a single communication.

17. The method of claim 16, wherein the request includes timing information identifying when a request should be served.

18. The method of claim 17, wherein the timing information indicates that the request should be served no earlier or no later than an identified time.

19. The method of claim 15, further comprising:
at the source system, receiving the request for the at least one associated module; and
at the source system, multicasting the at least one associated module to a plurality of receiver systems.

20. A system to communicate digital data in a digital television network, the system comprising:
a source system to provide a data stream that comprises modules of an interactive application; and
a plurality of receiver systems to receive the data stream, the plurality of receivers comprising:
a first receiver system to multicast a request for at least one module to the plurality of receiver systems; and
a second receiver system to receive said request and to multicast the at least one module to the plurality of receiver systems.

21. The system of claim 20, wherein the first receiver system and the second receiver system are on at least one of a peer-to-peer interactive television network, a client/server network, and a combined peer to peer and client/server network.

22. The system of claim 20, wherein the second receiver system retrieves the at least one requested module from a local cache and multicasts the at least one module to the plurality of receiver systems.

23. A method for requesting modules on an interactive television network comprising a plurality of receiver systems, the method comprising:
at a first receiver system, multicasting a request for at least one module to the plurality of receiver systems;
at a second receiver system, receiving the request for the at least one module; and
at the second receiver system, multicasting the requested at least one module to the plurality of receiver systems.

24. The method of claim 23, further comprising:
at the second receiver system, retrieving the module from a local cache.

25. The method of claim 24, wherein the interactive television network is one of a peer-to-peer interactive television network, a client/server television network, and a combined peer-to-peer and client server network.

26. A device comprising:
a receiver system to receive a list of modules from a source system and to determine whether to request a module if the module exists in the list of modules, the modules being multicast from the source system.

27. The device of claim 26, wherein the list comprises modules that will not be multicast from the source system over the interactive television network.

28. The device of claim 26, wherein the list comprises modules to be multicast from the source system over the interactive television network within a specific time period.

29. The device of claim 26, wherein the list comprises modules not to be multicast from the source system over the interactive television network within a specific time period.

30. A method comprising:
at a receiver system, receiving a list of modules from a source system; and
determining whether to request a module if the module exists in the list of modules.

31. The method of claim 30, wherein the list comprises modules to be multicast from the source system over an interactive television network.

32. The method of claim 31, wherein the list comprises each channel on which each module is to be multicast.

33. The method of claim 30, wherein the list comprises modules that will not be multicast from the source system over an interactive television network.

34. The method of claim 30, wherein the list comprises modules to be multicast from the source system over an interactive television network within a specific time period

35. The method of claim 30, wherein the list comprises modules that will not be multicast from the source system over the interactive television network within a specific time period.

36. A system comprising:
a carousel; and
a source system to generate a directory, the directory comprising a list of modules present in the carousel and a time each module will be multicast over an interactive television network, the source system further to multicast the directory to a plurality of receiver systems.

37. The system of claim 36, further comprising:
a first receiver system of the plurality of receiver systems, the first receiver system to receive the directory and to determine whether to perform a specific action upon accessing the directory.

38. The system of claim 36, wherein the action is one of launching an application, not to launch an application, and to exit an application.

39. The system of claim 36, wherein the determination is based on a time a specific module will be sent from the source system.

40. A method comprising:
at a source system, generating a directory of modules, the directory comprising a list of modules present in a carousel and a time each module is to be multicast on an interactive television network; and
multicasting the directory to a plurality of receiver systems.

41. The method of claim 40, further comprising:
at a receiver system, receiving the directory; and
determining whether to perform a specific action upon accessing the directory.

42. The method of claim 40, wherein the action is one of launching an application, not to launch an application, and to exit an application.

43. The method of claim 40, wherein the determination is based on the time a specific module will be sent from the source system.

44. A system to communicate data modules in an interactive television environment, the system comprising:
a source system to provide at least one application including at least one module; and
a plurality of receiver systems in communication with the source system via an interactive television network, wherein in response to a request for the at least one module from at least one receiver system, the source system multicasts the at least one module to the plurality of receiver systems.

45. The system of claim 44, wherein the at least one requesting receiver system packages request for multiple modules in a single request for communication to the source system.

46. The system of claim 44, wherein in response to a request for the at least one module, the source system multicasts a sequence of modules associated with the requested at least one module.

47. The system of claim 46, wherein the source system multicasts a list of module to be transmitted and the receiver systems refrain from submitting a request for a module included in the list.
